(19) United States
(12) Patent Application Publication
(10) Pub. No.: US 2024/0028386 A1
(43) Pub. Date: Jan. 25, 2024

(54) DEEP NEURAL NETWORK (DNN) COMPUTE LOADING AND TRAFFIC-AWARE POWER MANAGEMENT FOR MULTI-CORE ARTIFICIAL INTELLIGENCE (AI) PROCESSING SYSTEM

(71) Applicant: MEDIATEK INC., Hsinchu (TW)

(72) Inventors: En-Jui CHANG, Hsinchu (TW); Chih-Chung CHENG, Hsinchu (TW)

(73) Assignee: MEDIATEK INC., Hsinchu (TW)

(21) Appl. No.: 18/356,298

(22) Filed: Jul. 21, 2023

Related U.S. Application Data
(60) Provisional application No. 63/368,998, filed on Jul. 21, 2022.

(51) Int. Cl. G06F 9/48; G06N 3/063

(52) U.S. Cl. CPC G06F 9/485; G06N 3/063

(57) ABSTRACT

Aspects of the present disclosure provide a method for controlling a processing device to execute an application that employs a neural network (NN). The processing device includes a plurality of processing units arranged in a network-on-chip (NoC) to which the NN is mapped. For example, the method can include obtaining compiler information. The compiler information can include computing loads of the application on the processing units. The computing loads can relate a dataflow type of the NN. The method can also include determining a scaling factor for computing time of each of the processing units based on the computing loads, adjusting the computing time of the processing units based on the scaling factors, and enabling the processing units to perform their respective tasks of the application within their respective adjusted computing time.

### CROSS-REFERENCE TO RELATED APPLICATIONS

This present application claims the benefit of U.S. Provisional Application No. 63/368,998, “DNN Compute Loading and Traffic-Aware Power Management for Multi-core AI Processing System” filed on Jul. 21, 2022, which is incorporated herein by reference in its entirety.

### TECHNICAL FIELD

The present disclosure relates to neural networks (NNs), and specifically relates to selection of routing schemes for network-on-chip (NoC)-based deep NN (DNN) accelerators.

### BACKGROUND

The background description provided herein is for the purpose of generally presenting the context of the disclosure. Work of the presently named inventors, to the extent the work is described in this background section, as well as aspects of the description that may not otherwise qualify as prior art at the time of filing, are neither expressly nor impliedly admitted as prior art against the present disclosure.

Network-on-chip (NoC) interconnection is highly flexible and scalable. In order to reduce the design complexity of a deep neural network (DNN) accelerator implementation, an NoC-based DNN design becomes an attractive paradigm.

### SUMMARY

Aspects of the present disclosure provide a method for controlling a processing device to execute an application that employs a neural network (NN). The processing device can include a plurality of processing units arranged in a network-on-chip (NoC) to which the NN is mapped. For example, the method can include obtaining compiler information. The compiler information can include computing loads of the application on the processing units. The computing loads can relate a dataflow type of the NN. The method can further include determining a scaling factor for computing time of each of the processing units based on the computing loads, adjusting the computing time of the processing units based on the scaling factors, and enabling the processing units to perform their respective tasks of the application within their respective adjusted computing time.

In an embodiment, the scaling factor for the computing time of each of the processing units can be determined at each synchronization stage of the NN based on the computing load on the processing unit and a critical computing load on one of the processing units at the synchronization stage. For example, the dataflow type can be layer-by-layer tiling, the NN can include a plurality of layers each being partitioned into one or more tiles that correspond to the processing units, and the scaling factor for the computing time of each of the processing units can be determined in a corresponding tile of a corresponding layer of the NN based on the computing load of the corresponding tile and a critical computing load of a critical tile of the corresponding layer. As another example, the dataflow type can be cross-layer tiling, the NN can include a plurality of layers each being partitioned into one or more tiles, each of the processing units can process corresponding fused partitioned tiles of two or more of the layers, and the scaling factor for the computing time of each of the processing units can be determined in corresponding fused tiles at a corresponding synchronization stage of the NN based on the computing load of the corresponding fused tiles and a critical computing load of critical fused tiles at the corresponding synchronization stage. In some examples, the dataflow type can be layer pipeline tiling, the NN can include a plurality of layers each being partitioned into one or more tiles, the processing units, one after another at each synchronization stage, process corresponding tiles of corresponding layers sequentially, and the scaling factor for the computing time of each of the processing units can be determined in a corresponding tile of a corresponding layer of the NN based on the computing load of the corresponding tile and a critical computing load of a critical tile of the corresponding layer.

In an embodiment, the computing time of the processing units can be adjusted based on the scaling factors by employing dynamic voltage and frequency scaling (DVFS). For example, frequencies at which the processing units operate can be adjusted based on the scaling factors. As another example, voltages applied to the processing units can be adjusted based on the scaling factors.

Aspects of the present disclosure also provide a method for controlling a processing device to execute an application that employs a neural network (NN). The processing device can include a plurality of processing units arranged in a network-on-chip (NoC) to which the NN is mapped. For example, the method can include obtaining compiler information. The compiler information can include computing loads on the processing units for a plurality of dataflow types of the NN. The method can further include calculating a sum of the computing loads on the processing units for each of the dataflow types, selecting one of the dataflow types based on the sums, and enabling the processing units to perform their respective tasks of the application, the tasks corresponding to the computing loads on the processing units for the selected dataflow type.

In an embodiment, the method can further include determining a scaling factor for computing time of each of the processing units based on the computing loads, adjusting the computing time of the processing units based on the scaling factors, and enabling the processing units to perform their respective tasks of the application within their respective adjusted computing time.

Aspects of the present disclosure also provide an apparatus for executing an application that employs a neural network (NN). For example, the apparatus can include a plurality of processing units arranged in a network-on-chip (NoC) to which the NN is mapped. The apparatus can further include a receiving circuitry configured to receive compiler information. The compiler information can include computing loads of the application on the processing units. The computing loads can relate a dataflow type of the NN. The apparatus can further include a compiler coupled to the receiving circuitry and the processing units. The compiler is configured to determine a scaling factor for computing time of each of the processing units based on the computing loads, adjust the computing time of the processing units based on the scaling factors, and generate corresponding firmware for the processing units to execute to perform their respective tasks of the application within their respective adjusted computing time.

In an embodiment, the compiler can determine the scaling factor for the computing time of each of the processing units at each synchronization stage of the NN based on the computing load on the processing unit and a critical computing load on one of the processing units at the synchronization stage. For example, the dataflow type can be layer-by-layer tiling, the NN can include a plurality of layers each being partitioned into one or more tiles that correspond to the processing units, and compiler can determine the scaling factor for the computing time of each of the processing units in a corresponding tile of a corresponding layer of the NN based on the computing load of the corresponding tile and a critical computing load of a critical tile of the corresponding layer. As another example, the dataflow type can be cross-layer tiling, the NN can include a plurality of layers each being partitioned into one or more tiles, each of the processing units can process corresponding fused partitioned tiles of two or more of the layers, and the compiler can determine the scaling factor for the computing time of each of the processing units in corresponding fused tiles at a corresponding synchronization stage of the NN based on the computing load of the corresponding fused tiles and a critical computing load of critical fused tiles at the corresponding synchronization stage. In some examples, the dataflow type can be layer pipeline tiling, the NN can include a plurality of layers each being partitioned into one or more tiles, the processing units, one after another at each synchronization stage, process corresponding tiles of corresponding layers sequentially, and the compiler can determine the scaling factor for the computing time of each of the processing units in a corresponding tile of a corresponding layer of the NN based on the computing load of the corresponding tile and a critical computing load of a critical tile of the corresponding layer.

In an embodiment, the compiler can adjust the computing time of the processing units based on the scaling factors by employing dynamic voltage and frequency scaling (DVFS). For example, the compiler can adjust frequencies at which the processing units operate based on the scaling factors. As another example, the compiler can adjust voltages applied to the processing units based on the scaling factors.

In an embodiment, the compiler information can further include computing loads on the processing units for a plurality of dataflow types of the NN, and the compiler can be further configured to calculate a sum of the computing loads on the processing units for each of the dataflow types, select one of the dataflow types based on the sums, and generate the firmware that corresponds to the selected dataflow type. In another embodiment, the processing units can include deep learning accelerator (DLA) cores.

Note that this summary section does not specify every embodiment and/or incrementally novel aspect of the present disclosure or claimed invention. Instead, this summary only provides a preliminary discussion of different embodiments and corresponding points of novelty over conventional techniques. For additional details and/or possible perspectives of the present disclosure and embodiments, the reader is directed to the Detailed Description section and corresponding figures of the present disclosure as further discussed below.

### BRIEF DESCRIPTION OF THE DRAWINGS

Various embodiments of this disclosure that are proposed as examples will be described in detail with reference to the following figures, wherein like numerals reference like elements, and wherein:

FIG. 1A is a schematic diagram showing a deep neural network (DNN) that is mapped to a network-on-chip (NoC);

FIG. 1B shows a spatial reuse case of compute units;

FIG. 1C shows a spatiotemporal reuse case of compute units;

FIG. 2 is a schematic diagram showing a local router (LR) of the NoC forwarding packets/flits to a downstream router (DR) of the NoC;

FIG. 3 is a block diagram of an exemplary deep learning accelerator (DLA) core according to some embodiments of the present disclosure;

FIG. 4 shows computing time of critical and non-critical paths at a synchronization stage of an NN;

FIG. 5A shows a layer-by-layer tiling for a DNN;

FIG. 5B is a timing diagram illustrating a plurality of DLA cores processing corresponding tiles of each of the layers of the DNN of FIG. 5A;

FIG. 5C shows computing time, before and after adjustment, of critical and non-critical paths at a synchronization stage of the DNN of FIG. 5B;

FIG. 6A shows a cross-layer tiling for a DNN;

FIG. 6B is a timing diagram illustrating a plurality of DLA cores processing corresponding fused tiles of each of the layers of the DNN of FIG. 6A;

FIG. 6C shows computing time, before and after adjustment, of critical and non-critical paths at a synchronization stage of the DNN of FIG. 6B;

FIG. 7A is a timing diagram illustrating a plurality of DLA cores processing corresponding tiles of each of the layers of a DNN on which layer pipeline tiling is performed;

FIG. 7B shows computing time, before and after adjustment, of critical and non-critical paths at a synchronization stage of the DNN of FIG. 7A;

FIG. 8 shows a compiler determining scaling factors, adjusting computing time and generating corresponding firmware for DLAs to run according to some embodiments of the present disclosure;

FIG. 9 is a flow chart of an exemplary method according to some embodiments of the present disclosure;

FIG. 10 is a flow chart of another exemplary method according to some embodiments of the present disclosure; and

FIG. 11 is a functional block diagram of an exemplary apparatus according to some embodiments of the present disclosure.

### DETAILED DESCRIPTION OF EMBODIMENTS

Neural networks (NNs), e.g., deep neural networks (DNNs) and convolutional neural networks (CNN), have been widely used in a variety of cognitive applications, e.g., pattern recognition, image classification, computer vision, etc., and have achieved remarkable successes in some scenarios where the volume of data that are to be processed far exceeds the capability of human beings, e.g., self-driven cars. The scale of the DNNs is becoming larger and larger, in order to better infer data that are input to the DNNs. For example, current DNN models may consist of hundreds of layers and millions of parameters, e.g., weights, biases, kernels and activation functions, and involve complex vector and matrix computations at each layer. However, too large a DNN model may be too complex to be efficiently run on general hardware platforms. Network-on-chip (NoC), e.g., in the form of mesh, tree and ring, has been widely utilized in modern multi-core systems, e.g., deep learning accelerators (DLAs), for on-chip data transferring, and have provided a flexible, scalable and reusable solution to accelerate the operations of the DNN models.

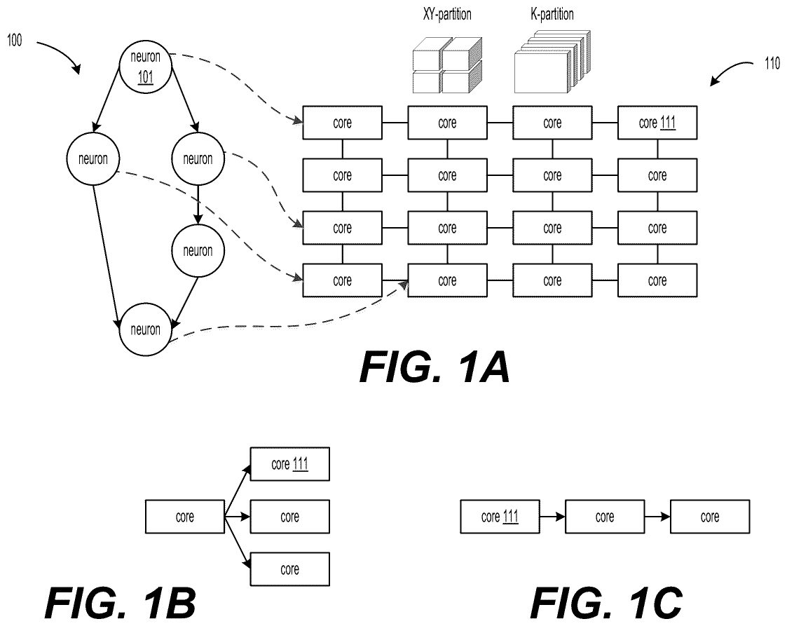

FIG. 1A is a schematic diagram showing a DNN 100, e.g., a CNN, which can be mapped or allocated to an NoC 110. The CNN 100 may consist of a plurality of neurons 101 that are arranged in multiple layers. The tensor data input to the layers can be partitioned into blocks of filters and channels, called tiles, e.g., XY-partition tiles and K-partition tiles. Each of the convolution partitioned tiles requires iterative use of the available compute units, e.g., a spatial reuse case, as shown in FIG. 1B, and a spatiotemporal reuse case, as shown in FIG. 1C.

The NoC 110 is a packet-switched network, which can enable a large number of processing elements (PEs), e.g., the cores 111, to communicate with each other. The NoC 110 may consist of routers and links, where each of the routers can be connected to a PE (or a group of PEs), and links can connect the routers to each other.

The DNN 100 can be mapped to the NoC 110 sequentially and randomly, or by some sophisticated algorithms, e.g., mapping a group of neurons that meet some specific requirements to a PE in order to reduce the overall data communication, packet latency and power consumption.

The tensor data input to the layers can be partitioned into XY-partition tiles and/or K-partition tiles, which may be different in sizes. As a result, the computing loadings of the cores 111 of the NoC 110 may be asymmetric due to different approaches of data tiling and mapping. Therefore, computing power may be wasted on non-critical loads. In average, 85% of the input buffers of the NoC 110 are idle, but still consume power. Besides, as the size of the NoC 110 increases, its network traffic load tends to become unbalanced, due to different approaches of data reuse, causing some routers to become hot-spot nodes.

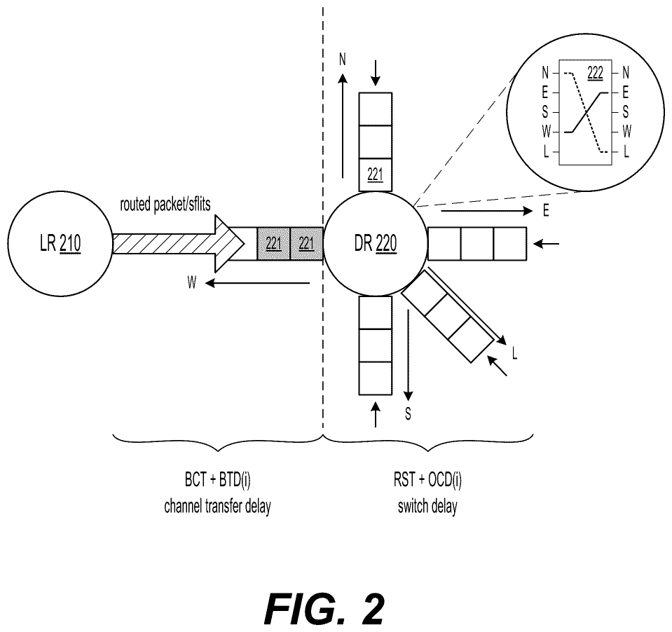

FIG. 2 is a schematic diagram showing a local router (LR) 210, e.g., a router of the NoC 110, forwarding packets/flits to a downstream router (DR) 220, e.g., another router of the NoC 110. In an embodiment, each of the LR 210 and the DR 220 can be modeled as a set of first-come-first-serve input buffers e.g., input buffers 221, a crossbar switch, e.g., a crossbar switch 222, which connect the input buffers 221 to one another, and some other components, e.g., an arbitrator. In an embodiment, the LR 210 and the DR 220 each have one or more ports for receiving flits transferred from other routers that neighbor the LR 210 and the DR 220 in different directions. For example, the input buffers 221 can buffer flits forwarded from upstream routers, e.g., the LR 210, in a plurality of directions, e.g., north N, east E, south S, west W and local L at different ports of the DR 220.

An incoming flit may spend a router latency L(i) on the input buffers 221 and the switch 222. The router latency L(i) is a performance metric that directly reflects the level of congestion. Therefore, by analyzing the router delay L(i), information about the path congestion can be modeled accurately. The input buffers 221 and the switch 222 are prone to congestion, which increases queueing delays in the routing path. Accordingly, the router latency L(i) may consist of two major delays: a channel transfer delay (BCT+BTD(i)) and a switch delay (RST+OCD(i)), and can be expressed by

L(i)(BCT+BTD(i))+(RST+OCD(i)), where

i{north,east,sourth,west}. (1)

The channel transfer delay (BCT+BTD(i)) is related to the transmission of flits in the input buffers 221, and may consist of a buffer constant time (BCT) and a buffer transfer delay (BTD(i)). The BCT is a constant delay that occurs when a flit is transferred through an empty input buffer 221. The BTD(i) is a time duration that an incoming header experiences during its shift toward the top of the input buffer 221 after flits accumulation. The switch delay (RST+OCD(i)) is related to allocation and switching of flits, and may consist of a router service time (RST) and an output contention delay (OCD). The RST is a constant delay for a router, e.g., the DR 220, processing a flit. The OCD(i) is time of contention with other flits. For example, the OCD(i) is zero if there is no contention, and the switch delay is equal to the RST. The routed flit needs to wait for some flits serviced by the switch 222 and be transferred through the router, e.g., the DR 220, and then the output port of the DR 220 can be released. The OCD(i) can also be treated as the switch waiting time.

The router latency L(i) can reflect how different buffer architectures, allocations, and routing algorithms influence the total path delay of a packet. However, not all parameters are required to be considered when identifying how the selection function affects the packet delay. Assume that all routers are homogeneous; that is, they have the same buffer architecture and switch architecture. Therefore, the BCT and the RST remain unchanged for all routers. If the path congestion occurs, the BTD(i) and the OCD(i) can become a significant part of the overall packet delay. When congestion information is used for selection function, the impacts of the BTD(i) and the OCD(i) shall be considered simultaneously. Therefore, to estimate the congestion level, the BTD(i) and the OCD(i) are analyzed predominantly. Also, the modeling of congestion levels for channels and switches can be discussed, respectively.

As mentioned previously, the BTD(i) is the delay caused by previous flits accumulated on the same input buffer 221. In an embodiment, it is assumed that the flits of different packets are not interleaved; that is, the body flit arrive immediately after the header flit arrives to a port, and the amount of time that the incoming header spends in the input buffer 221 is thus equivalent to the service time of previous flits in the switch 222. Therefore, the BTD(i) can be expressed as the product of an occupied buffer size B_{DR}(i) (i.e., the number of previous flits on the input buffer(i) 221 for downstream routers) and the RST, which is given by

BTD(i)=B_{DR}(i)×RST. (2)

The OCD(i) represents the average port-acquisition delay met by incoming flit due to the contention with other packets. If the incoming flit receives a failed output request, it must be blocked and then wait for a grant from the switch allocator. That is, the flit needs to wait for the packets that are in the other input buffers of the same router to pass. Therefore, the length of OCD(i) depends on two factors: a) the channel transfer delay of the packets in the other input buffers, and b) the contention probability between input channels. Namely, OCD(i) can be expressed as the expected channel transfer delay of competing packets in the other input buffers, which is a function of BTD(j) and contention probability (cᵢⱼₒ), and can be given by

OCD(i)=Σ_{j=1,j≠i}^{NCh}cᵢⱼₒBTD(j),

j∈{north,east,sourth,west}, (3)

where the term NCh denotes the number of channels in a router (e.g., for 2-D mesh, NCh=5 directions), and the coefficient cᵢⱼₒ represents the contention probability between input channels i and j; that is, cᵢⱼₒ is the probability that packets from input channels i and j compete for a common output o. It can be expressed as

$${C}_{ijo} = \{ \begin{matrix}{f}_{io} \times {f}_{jo} , i \neq j \\ 0 , i = j\end{matrix} , \qquad ( 4 )$$

where fᵢₒ and fⱼₒ represent the probabilities of the presence of the packets in the input buffers (i) and (j) both toward the input buffer (o), respectively. Besides, since an incoming packet cannot be competed with itself, cᵢⱼₒ is 0 when i is equal to j.

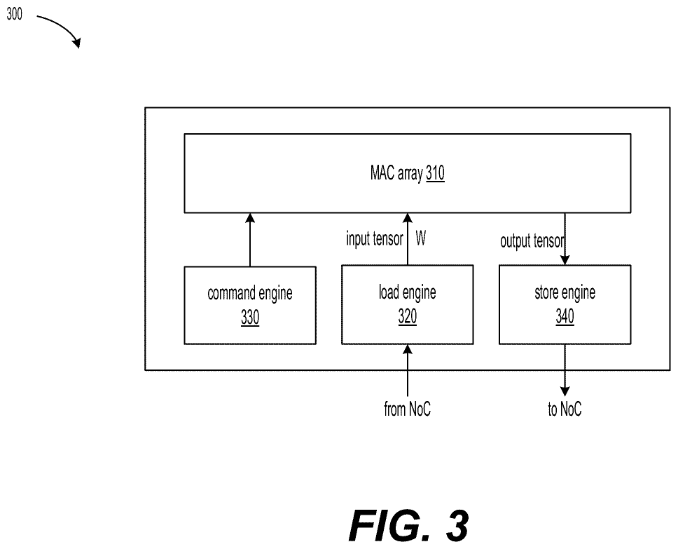

FIG. 3 is a block diagram of an exemplary DLA core 300 according to some embodiments of the present disclosure. For example, the DLA core 300 can include a multiply-accumulate (MAC) array 310 that may include one or more MAC units, a load engine 320 coupled to the MAC array 310 that receives tensor data from other cores of a NoC and input the tensor data to the MAC array 310, a command engine 330 coupled to the MAC array 310 that is configured to control the MAC array 310 to perform a variety of operations on the input tensor data, and a store engine 340 coupled to the MAC array 310 that receives the tensor data that are processed and output from the MAC array 310 and transfers the processed tensor data to other cores of the NoC. It takes a DLA core (k) a core latency L_{cores}(k) to process and output the tensor data, which is equal to the computing load CLₖ of the DLA core (k) divided by the number of MAC operations (or MAC units) in the DLA core (k), and is expressed as

$${L}_{cores} ( k ) = \frac{{CL}_{k}}{MAC} . \qquad ( 5 )$$

The energy model of multiple cores, e.g., the DLA cores 300, can be expressed by

$${E}_{cores} = {\sum }_{k ∈ {ID}_{core}} {P}_{computing , k ( v , {f}_{core} )} \times \frac{{CL}_{k}}{MAC \times {f}_{core}} , \qquad ( 6 )$$

wherein P_{computing}, k is the power of a computing DLA core, k is the number of DLA cores in an NoC, and v and f_{core} are the operating voltage and frequency of the DLA core, respectively.

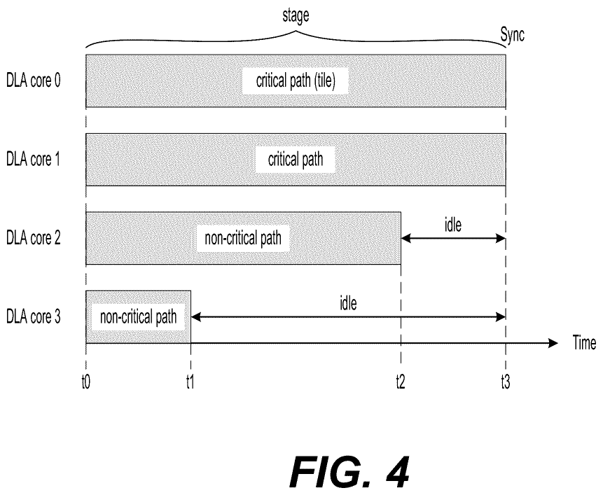

As previously mentioned, the tensor data input to the layers of a DNN can be partitioned into a plurality of tiles, for example, XY-partition tiles or K-partitioned tiles, which can then be mapped to an NoC that corresponds to a plurality of DLA cores. However, the partitioned tiles may be different in size from one another, and, accordingly, computing loads on the DLA cores may be unbalanced. As a result, it takes asymmetric computing time for the DLA cores to complete theirs respective tasks. As shown in FIG. 4, four tiles are partitioned from a layer that are different in size, and four DLA cores 0-3 that correspond to the four tiles thus have unbalanced computing loads thereon and complete their respective tasks at different time. For example, the DLA cores 0 and 1 have the greatest computing loads thereon and cannot complete their tasks until time t3. By contrast, the DLA cores 2 and 3 have less computing loads thereon and can complete their respective tasks earlier at time t2 and time t1, respectively. As the computing results of the DLA cores 0-3 at the current stage will be forwarded to some other DLA cores in the NoC at a next stage (e.g., a next layer of the DNN) synchronously due to data dependency, the DLA cores 2 and 3 are idle since time t2 and time t1, respectively, but, however, still consume power. Therefore, energy is unnecessarily wasted for the non-critical computing loads on the DLA cores 2 and 3.

According to the present disclosure, the asymmetric computing time of the DLA cores 0-3 are adjusted to become symmetric (or equal) so that the DLA cores 0-3 can complete their respective tasks at the same time during the synchronization stage. Therefore, none of the DLA cores 0-3 are idle and waste energy before the computing results at the current stage are forwarded to some other DLA cores at the next stage.

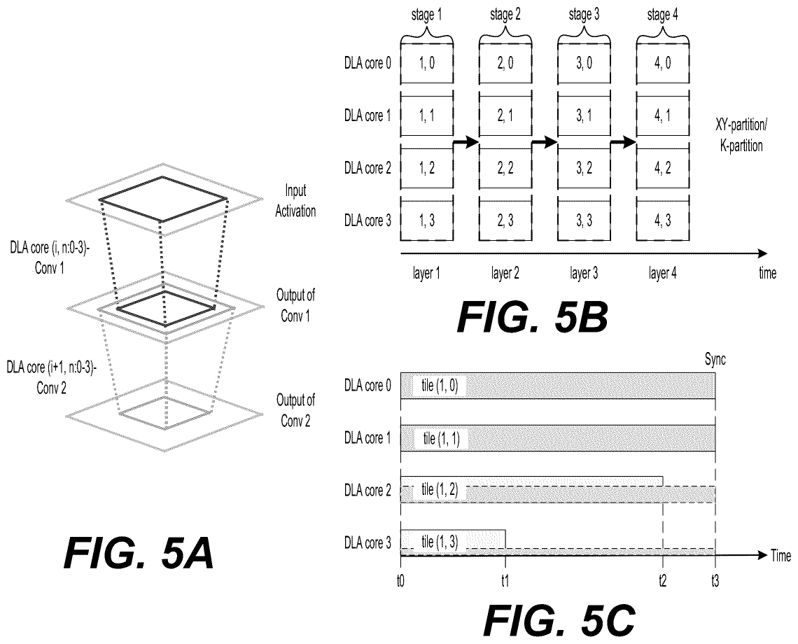

The tensor data input to layers of a DNN can be partitioned into one or more tiles in various manners. FIG. 5A shows a layer-by-layer tiling (layer-based execution) for a DNN. FIG. 5B is a timing diagram illustrating a plurality of DLA cores processing corresponding tiles of each of the layers of the DNN. For example, each of the layers 1-4 of the DNN can be partitioned into four tiles, e.g., tiles (1, 0)-(1, 3), tiles (2, 0)-(2, 3), tiles (3, 0)-(3, 3) and tiles (4, 0)-(4, 3), and four DLA cores 0-3 are provided to perform convolution operations on corresponding tiles of each of the layers 1-4, e.g., on the tiles (1, 0)-(1, 3) of the layer 1. After completing their respective tasks on the tiles (1, 0)-(1, 3), respectively, of the current layer (or stage), e.g., the layer 1, the DLA cores 0-3 start processing the four tiles (2, 0)-(2, 3) of a next layer (or stage), e.g., the layer 2, of the DNN. In order to ensure that all of the four DLA cores 0-3 can complete their respective tasks at the same time and none of them are idle, the computing time of the DLA cores 0-3, if being asymmetric, shall be adjusted to become equal. In an embodiment, a computing time of a critical tile (or path) of each of the layers 1-4, e.g., a critical computing time T_{critical_per_layer} (i), can be determined by

$${T}_{critical \_ per \_ layer} ( i ) = max \{ {T}_{tile} ( i , n ) \} , \qquad ( 7 )$$

where i denotes the current layer, and n denotes the DLA core n that processes the tile (i, n). After the critical computing time T_{critical_per_layer} (i) is determined, a scaling factor (i, n) for the computing time of the other tiles n of each layer can be determined. In an embodiment, the scaling factor (i, n) for the computing time of the other tiles (i, n) can be determined by

$$scaling factor ( i , n ) = \frac{{T}_{tile} ( i , n )}{{T}_{critical \_ per \_ layer} ( i )} . \qquad ( 8 )$$

The computing time of the other DLA cores n that process the other tiles (i, n) can be adjusted based on the scaling factors (i, n). For example, as shown in FIG. 5C, the critical computing time T_{critical_per_layer} (1) of the layer 1 is t3, occurring in the tiles (1, 0) and (1, 1), the scaling factors (1, 2) and (1, 3) for the computing time of the tiles (1, 2) and (1, 3) are t2/t3 and t1/t3, respectively, which are both less than one. In an embodiment, the computing time of the DLA cores 2 and 3 can be adjusted based on their respective scaling factors (1, 2) and (1, 3) by employing, for example, dynamic voltage and frequency scaling (DVFS). For example, the frequencies at which the DLA cores 2 and 3 operate can be adjusted to be the critical frequency of the DLA cores 0 and 1 multiplying the scaling factors (1, 2) and (1, 3), respectively. As another example, the voltages applied to the DLA cores 2 and 3 can be adjusted to be the critical voltage of the DLA cores 0 and 1 multiplying the scaling factors (1, 2) and (1, 3), respectively. Therefore, the DLA cores 2 and 3 can complete their tasks at the same time as the DLA cores 0 or 1 do, i.e., time t3, and consume less energy as their frequencies and/or voltages are reduced.

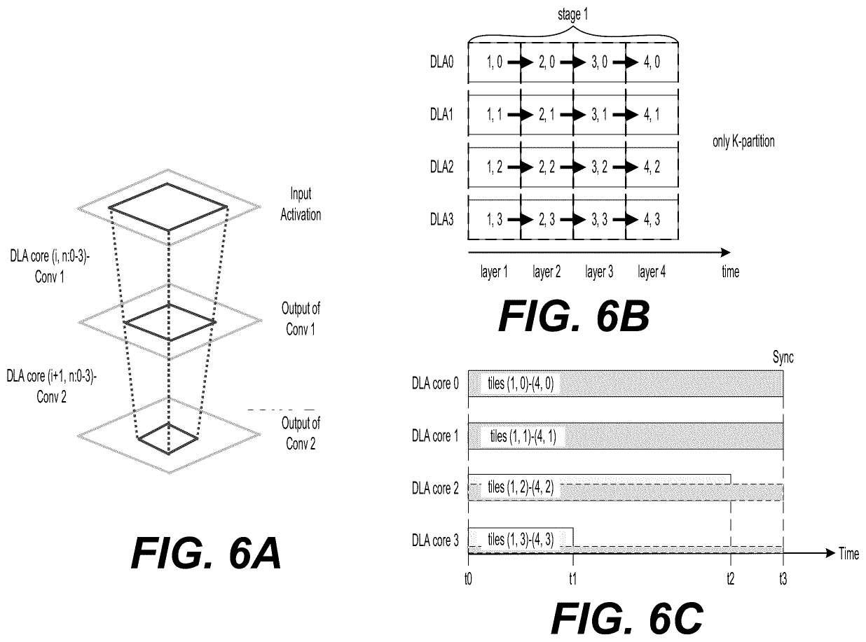

FIG. 6A shows a cross-layer tiling (multi-layer execution) for a DNN, such as a fused-layer CNN. FIG. 6B is a timing diagram illustrating a plurality of DLA cores processing corresponding tiles of each of the layer of the DNN. In each synchronization stage of the cross-layer tiling, two convolutional tiles at neighboring layers will be fused sequentially until the tiles in the last layer are smaller than a corresponding kernel. For example, four tiles (1, 0)-(4, 0), (1, 1)-(4, 1), (1, 2)-(4, 2) or (1, 3)-(4, 3) in each of the layers 1-4 can be fused sequentially, and four DLA cores 0-3 are provided to perform the fusion of their respective tiles of a corresponding one of the layers 1-4, as shown in FIG. 6B. After completing their respective tasks on the tiles (1, 0)-(4, 0), (1, 1)-(4, 1), (1, 2)-(4, 2) or (1, 3)-(4, 3), respectively, at the current synchronization stage, e.g., including the layers 1-4 that are fused, the DLA cores 0-3 start processing the tasks on the tiles (1, 0)-(4, 0), (1, 1)-(4, 1), (1, 2)-(4, 2) or (1, 3)-(4, 3) at a next synchronization stage of the DNN. In order to ensure that all of the four DLA cores 0-3 complete their respective tasks at the same time and none of them are idle, the computing time of the DLA cores 0-3, if being asymmetric, shall be adjusted to become equal. In an embodiment, a computing time of a critical path (including four tiles) at each synchronization stage, e.g., a critical computing time T_{critical_per_fused_layer} (i), can be determined by

$${T}_{critical \_ per \_ fused \_ layer} ( i ) = max \{ {\sum }_{i ∈ ID \_ fused \_ layer} {T}_{tile} ( i , n ) \} , \qquad ( 9 )$$

where i denotes the fused tiles (i, n) at the current synchronization stage (i) and n denotes the DLA core n that processes the fused tiles (i, n). After the critical computing time T_{critical_per_fused_layer} (i) is determined, a scaling factor (i, n) of the other fused tiles (i, n) at the current synchronization stage can be determined. In an embodiment, the scaling factor (i, n) of the other tiles (i, n) can be expressed by

$$scaling factor ( i , n ) = \frac{{\sum }_{i ∈ ID \_ fused \_ layer} {T}_{tile} ( i , n )}{{T}_{critical \_ per \_ fused \_ layer} ( i )} . \qquad ( 10 )$$

The computing time of the other DLA cores n that process the other fused tiles (i, n) can be adjusted based on the scaling factors (i, n). For example, as shown in FIG. 6C, the critical computing time T_{critical_per_fused_layer} (1) at the synchronization stage 1 is t3, occurring in the fused tiles (1, 0), (2, 0), (3, 0) and (4, 0) and the fused tiles (1, 1), (2, 1), (3, 1) and (4, 1), the scaling factor (1, 2) of the fused tiles (1, 2), (2, 2), (3, 2) and (4, 2) and the scaling factor and (1, 3) of the fused tiles (1, 3), (2, 3), (3, 3) and (4, 3) are t2/t3 and t1/t3, respectively, which are both less than one. In an embodiment, the computing time of the DLA cores 2 and 3 can be adjusted based on their respective scaling factors (1, 2) and (1, 3) by employing DVFS. For example, the frequencies at which the DLA cores 2 and 3 operate can be adjusted to be the critical frequency of the DLA cores 0 and 1 multiplying the scaling factors (1, 2) and (1, 3), respectively. As another example, the voltages applied to the DLA cores 2 and 3 can be adjusted to be the critical voltage of the DLA cores 0 and 1 multiplying the scaling factors (1, 2) and (1, 3), respectively. Therefore, the DLA cores 2 and 3 can complete their tasks at the same time as the DLA cores 0 and 1 do, i.e., time t3, and consume less energy as their frequencies and/or voltages are reduced.

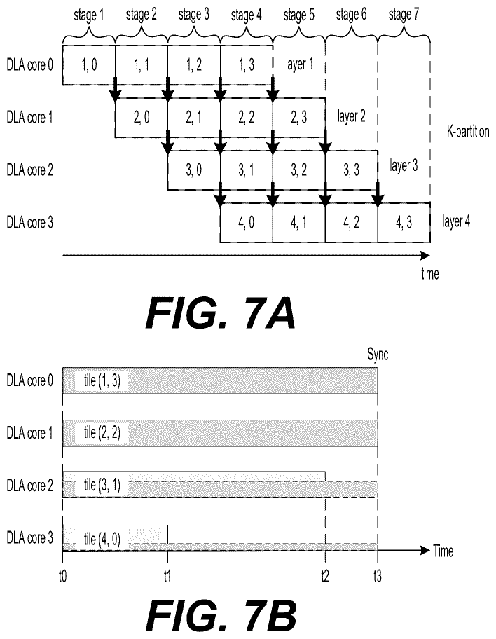

FIG. 7A is a timing diagram illustrating a plurality of DLA cores each processing a plurality of tiles of a corresponding layer of a DNN. Another multi-layer execution, e.g., layer pipeline tiling, can be performed on the DNN. In an embodiment, each layer can be partitioned into a plurality of tiles, and the DLA cores, one after another at each synchronization stage, process the tiles of their corresponding layers sequentially. For example, at stage 1, the DLA core 0 processes the first tile (1, 0) of the layer 1; at stage 2, after the DLA core 0 has processed the first tile (1, 0) of the layer 1, the DLA core 0 processes the second tile (1, 1) of the layer 1, and the DLA core 1 processes the first tile (2, 0) of the layer 2: at stage 3, after the DLA core 0 has processed the second tile (1, 1) of the layer 1 and the DLA core 1 has processed the first tile (2, 0) of the layer 2, the DLA core 0 processes the third tile (1, 2) of the layer 1, the DLA core 1 processes the second tile (2, 1) of the layer 2, and the DLA core 2 processes the first tile (3, 0) of the layer 3: at stage 4, after the DLA core 0 has processed the third tile (1, 2) of the layer 1, the DLA core 1 has processed the second tile (2, 1) of the layer 2 and the DLA core 2 has processed the first tile (3, 0) of the layer 3, the DLA core 0 processes the fourth tile (1, 3) of the layer 1, the DLA core 1 processes the third tile (2, 2) of the layer 2, the DLA core 2 processes the second tile (3, 1) of the layer 3, and the DLA core 3 processes the first tile (4, 0) of the layer 4; and so on.

In order to ensure that all of the four DLA cores 0-3 complete their respective tasks at the same time and none of them are idle, the computing time of the DLA cores 0-3, if being asymmetric, shall be adjusted to become equal. In an embodiment, a computing time of a critical path (or tile) of each stage, e.g., a critical computing time T_{critical_per_stage} (i), can be determined by

$${T}_{critical \_ per \_ stage} ( j ) = max \{ {\sum }_{i ∈ {ID}_{layer} , n ∈ {ID}_{tile} , i + n = j , J \geq 1} {T}_{tile} ( i , n ) \} , \qquad ( 11 )$$

where j denotes the current stage j, n denotes the currently processed critical tile (i, n) of each layer n, and i denotes the DLA core n that processes the current tile (i, n) of the layer n. After the critical computing time T_{critical_per_stage} (j) is determined, a scaling factor (i, j, n) of the other tiles (i, n) at the current stage j can be determined. In an embodiment, the scaling factor (i, j, n) of the other tiles (i, n) can be determined by

$$scaling factor ( i , n ) = \frac{{T}_{tile} ( i , n )}{{T}_{critical \_ per \_ stage} ( i )} . \qquad ( 12 )$$

The computing time of the other DLA cores n that process the other tiles (i, n) can be adjusted based on the scaling factors (i, n). For example, as shown in FIG. 7B, at stage 4, the critical computing time T_{critical_per_stage} (1) is t3, occurring in the tile (1, 3), the scaling factors (3, 1) and (4, 0) of the tiles (3, 1) and (4, 0) are t2/t3 and t1/t3, respectively, which are both less than one. In an embodiment, the computing time of the DLA cores 2 and 3 can be adjusted based on their respective scaling factors (3, 1) and (4, 0) by employing DVFS. For example, the frequencies at which the DLA cores 2 and 3 operate can be adjusted to be the critical frequency of the DLA cores 0 and 1 multiplying the scaling factors (3, 1) and (4, 0), respectively. As another example, the voltages applied to the DLA cores 2 and 3 can be adjusted to be the critical voltage of the DLA cores 0 and 1 multiplying the scaling factors (3, 1) and (4, 0), respectively. Therefore, the DLA cores 2 and 3 can complete their tasks at the same time as the DLA cores 0 and 1 do, i.e., time t3, and consume less energy as their frequencies and/or voltages are reduced.

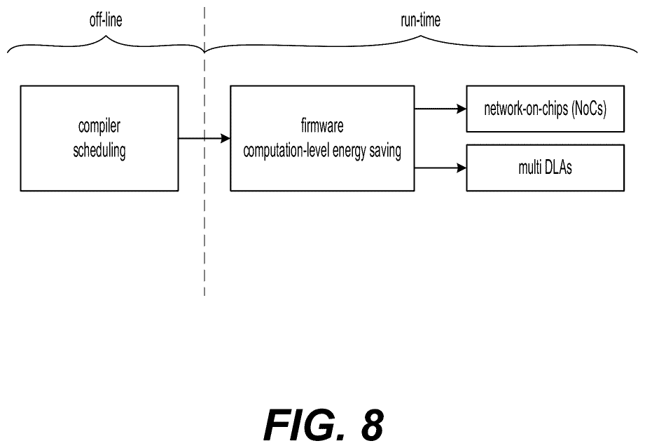

As a designer generally has an in-depth knowledge of an application that he is about to run employing a network, e.g., a DNN, and can decide what type of tiling he is going to employ to partition each layer of the DNN to get to know the loads on and computing time of the partitioned tiles of each layer or fused tiles at each stage and calculate the scaling factor for each non-critical path of the DNN. For example, the knowledge, the load information and the scaling factors can be used by an off-line compiler to generate firmware, which may relate to computation-level energy saving, for the NoC, e.g., multi-DLAs, to execute at run-time, as shown in FIG. 8.

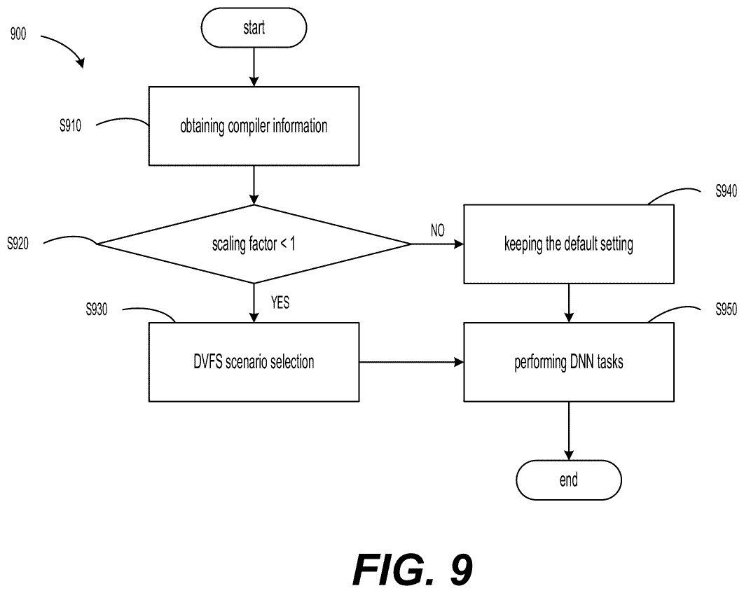

FIG. 9 is a flow chart of an exemplary method 900 according to some embodiments of the present disclosure. The method 900 can be used to, given a dataflow (or tiling) type of a network, e.g., a DNN, employed by an application to run, adjust computing time of a plurality of processing cores, e.g., DLA cores, that are arranged in an NoC to which the DNN is mapped. In various embodiments, some of the steps of the method 900 shown can be performed concurrently or in a different order than shown, can be substituted by other method steps, or can be omitted. Additional method steps can also be performed as desired. Aspects of the method 900 can be implemented by a compiler, for example.

At step S910, compiler information is obtained. In an embodiment, given a dataflow type, the compiler information can include loads on and/or computing time of the DLA cores. For example, given a layer-by-layer tiling (layer-based execution) for the DNN, the compiler information can include the computing loads on or computing time of the DLA cores to which one or more tiles of each of the layers of the DNN are mapped, as shown in FIGS. 5A and 5B. As another example, given a cross-layer tiling (multi-layer execution) for the DNN, such as a fused-layer CNN, the compiler information can include the loads on and/or computing time of the DLA cores to which one or more fused tiles of a plurality of layers at each synchronization stage of the CNN are mapped, as shown in FIGS. 6A and 6B. In another example, given another multi-layer execution, e.g., layer pipeline tiling, the compiler information can include the computing loads on or computing time of the DLA cores to which one or more tiles of each of the layers of the DNN are mapped, as shown in FIG. 7A.

At step S920, it is determined as to whether a scaling factor for the computing time of each of the DLA cores at each synchronization stage (or layer) is less than one. If it is determined that the scaling factor for the computing time of a DLA core is less than one, regarding the DLA core, the method 900 proceeds to step S930; otherwise, the method 900 proceeds to step S940. In an embodiment, a critical computing time can be determined based on the loads on the tiles at each synchronization stage, and then scaling factors for non-critical loads on and/or computing time of the DLA cores to which the tiles are mapped can be calculated. For example, as shown in FIG. 5C, the load on the tile (1, 0) in the layer 1 corresponds to a critical path, the computing time of the DLA core 0 to which the tile (1, 0) is mapped is thus critical, and the scaling factors for the computing time of the other DLA cores 1, 2 and 3 can be calculated based on their loads (or computing time) and the critical computing time, e.g., calculated by dividing their computing time by the critical computing time according to equation (8). In the case scenario of FIG. 5C, the scaling factors for the computing time of the DLA cores 1, 2 and 3 are t3/t3, t2/t3 and t1/t3, respectively. As the scaling factor for the computing time of the DLA core 1 is not less than one, the method 900, regarding the LDA core 1, proceeds to step S940. By contrast, the method 900 proceeds to step S930 for the DLA cores 2 and 3 as their scaling factors, i.e., t2/t3 and t1/t3, are less than one.

As another example, as shown in FIG. 6C, the loads on the fused tiles (1, 0)-(4, 0) at the synchronization stage 1, e.g., including the layers 1-4, corresponds to a critical path, the computing time of the DLA core 0 to which the fused tiles (1, 0)-(4, 0) are mapped is thus critical, and the scaling factors for the computing time of the other DLA cores 1, 2 and 3 can be calculated based on their loads (or computing time) and the critical computing time, e.g., calculated by dividing their computing time by the critical computing time according to equation (10). In the case scenario of FIG. 6C, the scaling factors for the computing time of the DLA cores 1, 2 and 3 are t3/t3, t2/t3 and t1/t3, respectively. As the scaling factor for the computing time of the DLA core 1 is not less than one, the method 900, regarding the DLA core 1, proceeds to step S940. By contrast, the method 900 proceeds to step S930 for the DLA cores 2 and 3 as their scaling factors, i.e., t2/t3 and t1/t3, are less than one.

In yet another example, as shown in FIG. 7B, the load on the tile (1, 3) of the layer 1 at the synchronization stage 4 corresponds to a critical path, the computing time of the DLA core 0 to which the tile (1, 3) is mapped is thus critical, and the scaling factors for the computing time of the other DLA cores 1, 2 and 3 can be calculated based on their loads (or computing time) and the critical computing time, e.g., calculated by dividing their computing time by the critical computing time according to equation (12). In the case scenario of FIG. 7B, the scaling factors for the computing time of the DLA cores 1, 2 and 3 are t3/t3, t2/t3 and t1/t3, respectively. As the scaling factor for the computing time of the DLA core 1 is not less than one, the method 900, regarding the DLA core 1, proceeds to step S940. By contrast, the method 900 proceeds to step S930 for the DLA cores 2 and 3 as their scaling factors, i.e., t2/t3 and t1/t3, are less than one.

At step S930, the asymmetric computing time of the DLA cores 2 and 3 are adjusted such that they are longer than their original computing time or equal to the critical computing time of the DLA core 0. In an embodiment, the computing time of the DLA cores 2 and 3 can be adjusted based on their respective scaling factors, e.g., t2/t3 and t1/t3, by employing, for example, DVFS. For example, the frequencies at which the DLA cores 2 and 3 operate can be adjusted to be the critical frequency of the DLA core 0 multiplying the scaling factors, i.e., t2/t3 and t1/t3, respectively. As another example, the voltages applied to the DLA cores 2 and 3 can be adjusted to be the critical voltage of the DLA core 0 multiplying the scaling factors, i.e., t2/t3 and t1/t3, respectively. The method 900 then proceeds to step S950.

At step S940, the symmetric computing time of the DLA core 1 is kept at its default setting. As the computing time of the DLA core 1 is equal to the critical computing time of the DLA core 0, the DLA core 1 will complete executing its task at the same time as the DLA core 0 does, and will not be idle during this synchronization stage. Therefore, no adjustment to the computing time is required for the DLA core 1.

At step S950, the DLA cores 0-3 perform their respective DNN tasks. As the computing time of all the DLA cores 0-3 are adjusted to become symmetric at this synchronization stage and some of the non-critical DLA cores, e.g., the DLA cores 2 and 3, have their frequencies and/or voltages reduced, none of the DLA cores 0-3 are idle during this synchronization stage and the power consumption is thus reduced.

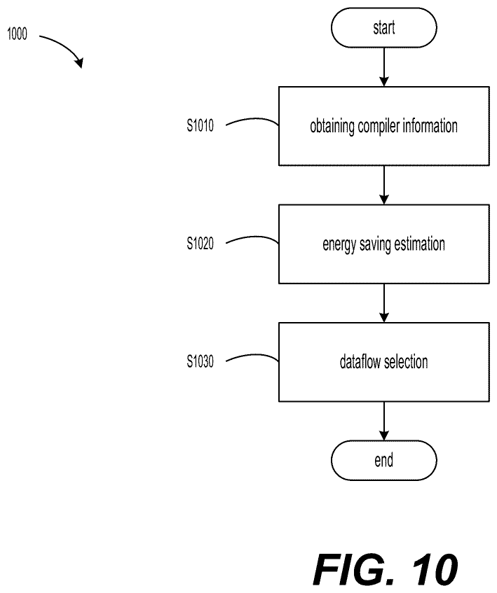

FIG. 10 is a flow chart of an exemplary method 1000 according to some embodiments of the present disclosure. The method 1000 can be used to select one from a plurality dataflow types that corresponds to the least power consumption. In various embodiments, some of the steps of the method 1000 shown can be performed concurrently or in a different order than shown, can be substituted by other method steps, or can be omitted. Additional method steps can also be performed as desired. Aspects of the method 1000 can be implemented by a compiler, for example.

At step S1010, compiler information is obtained. In an embodiment, the compiler information can include loads on and/or computing time of the DLA cores for a plurality of types of dataflow, e.g., layer-based execution such as layer-by-layer tiling shown in FIG. 5B and multi-layer execution such as cross-layer tiling shown in FIG. 6B and layer pipeline tiling shown in FIG. 7A, and scaling factors for the computing time of the DLA cores, which can be calculated at step S920.

At step S1020, the power consumption of the DLA cores to which the dataflow types are mapped is determined. In an embodiment, an average scaling factor for the computing time of the DLA cores for each of the dataflow types can be calculated. For example, the average scaling factor can be determined by calculating a sum of all the computing loads on or computing time of the DLA cores and dividing the sum by a product of the numbers of the DLA cores and the stages and the critical computing time.

At step S1030, one of the dataflow types is selected. For example, one of the dataflow types that corresponds to the smallest average scaling factor can be selected to be mapped to the DLA cores. In an embodiment, step S1030 can be followed by step S920 of the method 900.

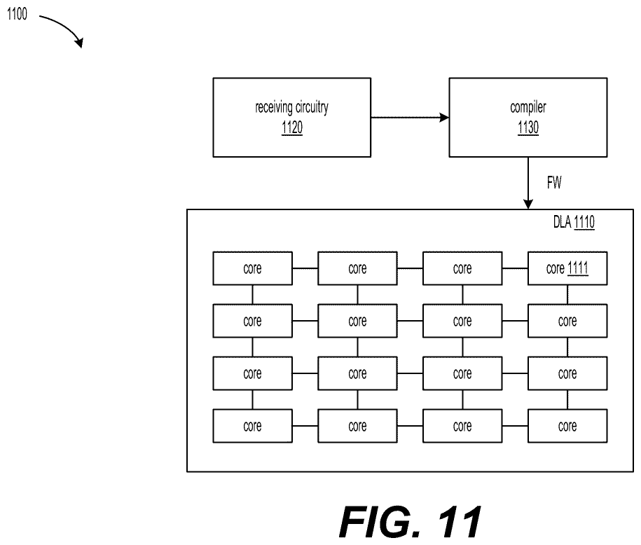

FIG. 11 is a functional block diagram of an exemplary apparatus 1100 according to some embodiments of the present disclosure. In an embodiment, the apparatus 1100 can be an electronic device, such as a mobile phone. In some embodiments, the apparatus 1100 can be used to implement the methods 900 and 1000.

In an embodiment, the apparatus 1100 can include a receiving circuitry 1120, a compiler 1130 coupled to the receiving circuitry 1120, and a DLA 1110 coupled to the compiler 1130. The receiving circuitry 1120 can receive compiler information for the compiler 1130 to generate firmware FW that the DLA 1110 can execute at run-time. For example, the compiler information can include loads on and/or computing time of the DLA 1110 for a plurality of dataflow types, e.g., layer-based execution such as layer-by-layer tiling shown in FIG. 5B and multi-layer execution such as cross-layer tiling shown in FIG. 6B and layer pipeline tiling shown in FIG. 7A.

In an embodiment, the DLA 1110 can include a plurality of DLA cores 1111 arranged in an NoC. The DLA cores 1111 can execute the firmware FW generated by the compiler 1130 at run-time.

In an embodiment, the compiler 1130 can, for each dataflow type, determine a critical computing time for one of DLA cores 1111 that performs a task in a critical path at each synchronization stage, calculate scaling factors for computing time of the other DLA cores 1111 that perform tasks in non-critical paths, and calculate an average scaling factor for computing time of the DLA cores 1111, and can thus select one of the dataflow types based on the calculated the average scaling factors. For example, when determining that the smallest average scaling factor corresponds to the layer-by-layer tiling, the compiler 1130 can adjust the computing time of the DLA cores 1111 based on their respective scaling factors, and generate the firmware FW for the DLA cores 1111 to execute at run-time, in order to minimize the energy consumption of the NoC. In an embodiment, the computing time of the DLA cores 1111 can be adjusted based on their respective scaling factors by employing DVFS. For example, the frequencies at which some of the DLA cores 1111 that are non-critical operate can be adjusted to be the critical frequency of one of the DLA cores 1111 that corresponds to the critical computing time at each synchronization stage multiplying the their respective scaling factors. As another example, the voltages applied to the non-critical DLA cores 1111 can be adjusted to be the critical voltage of the critical DLA core multiplying their respective scaling factors. Therefore, the non-critical DLA cores 1111 can complete their tasks at the same time as the critical DLA cores 1111 does at each synchronization stage, and consume less energy as their frequencies and/or voltages are reduced.

While aspects of the present disclosure have been described in conjunction with the specific embodiments thereof that are proposed as examples, alternatives, modifications, and variations to the examples may be made. Accordingly, embodiments as set forth herein are intended to be illustrative and not limiting. There are changes that may be made without departing from the scope of the claims set forth below.

What is claimed is:

1. A method for controlling a processing device to execute an application that employs a neural network (NN), the processing device including a plurality of processing units arranged in a network-on-chip (NoC) to which the NN is mapped, the method comprising:
obtaining compiler information, the compiler information including computing loads of the application on the processing units, the computing loads relating a dataflow type of the NN;
determining a scaling factor for computing time of each of the processing units based on the computing loads;
adjusting the computing time of the processing units based on the scaling factors; and
enabling the processing units to perform their respective tasks of the application within their respective adjusted computing time.

2. The method of claim 1, wherein the scaling factor for the computing time of each of the processing units is determined at each synchronization stage of the NN based on the computing load on the processing unit and a critical computing load on one of the processing units at the synchronization stage.

3. The method of claim 2, wherein the dataflow type is layer-by-layer tiling, the NN includes a plurality of layers each being partitioned into one or more tiles that correspond to the processing units, and the scaling factor for the computing time of each of the processing units is determined in a corresponding tile of a corresponding layer of the NN based on the computing load of the corresponding tile and a critical computing load of a critical tile of the corresponding layer.

4. The method of claim 2, wherein the dataflow type is cross-layer tiling, the NN includes a plurality of layers each being partitioned into one or more tiles, each of the processing units processes corresponding fused partitioned tiles of two or more of the layers, and the scaling factor for the computing time of each of the processing units is determined in corresponding fused tiles at a corresponding synchronization stage of the NN based on the computing load of the corresponding fused tiles and a critical computing load of critical fused tiles at the corresponding synchronization stage.

5. The method of claim 2, wherein the dataflow type is layer pipeline tiling, the NN includes a plurality of layers each being partitioned into one or more tiles, the processing units, one after another at each synchronization stage, process corresponding tiles of corresponding layers sequentially, and the scaling factor for the computing time of each of the processing units is determined in a corresponding tile of a corresponding layer of the NN based on the computing load of the corresponding tile and a critical computing load of a critical tile of the corresponding layer.

6. The method of claim 1, wherein the computing time of the processing units is adjusted based on the scaling factors by employing dynamic voltage and frequency scaling (DVFS).

7. The method of claim 6, wherein frequencies at which the processing units operate are adjusted based on the scaling factors.

8. The method of claim 6, wherein voltages applied to the processing units are adjusted based on the scaling factors.

9. A method for controlling a processing device to execute an application that employs a neural network (NN), the processing device including a plurality of processing units arranged in a network-on-chip (NoC) to which the NN is mapped, the method comprising:
obtaining compiler information, the compiler information including computing loads on the processing units for a plurality of dataflow types of the NN;
calculating a sum of the computing loads on the processing units for each of the dataflow types;
selecting one of the dataflow types based on the sums; and
enabling the processing units to perform their respective tasks of the application, the tasks corresponding to the computing loads on the processing units for the selected dataflow type.

10. The method of claim 9, further comprising:
determining a scaling factor for computing time of each of the processing units based on the computing loads;
adjusting the computing time of the processing units based on the scaling factors; and
enabling the processing units to perform their respective tasks of the application within their respective adjusted computing time.

11. An apparatus for executing an application that employs a neural network (NN), the apparatus comprising:
a plurality of processing units arranged in a network-on-chip (NoC) to which the NN is mapped;
a receiving circuitry configured to receive compiler information, the compiler information including computing loads of the application on the processing units, the computing loads relating a dataflow type of the NN; and
a compiler coupled to the receiving circuitry and the processing units, the compiler configured to determine a scaling factor for computing time of each of the processing units based on the computing loads, adjust the computing time of the processing units based on the scaling factors, and generate corresponding firmware for the processing units to execute to perform their respective tasks of the application within their respective adjusted computing time.

12. The apparatus of claim 11, wherein the compiler determines the scaling factor for the computing time of each of the processing units at each synchronization stage of the NN based on the computing load on the processing unit and a critical computing load on one of the processing units at the synchronization stage.

13. The apparatus of claim 12, wherein the dataflow type is layer-by-layer tiling, the NN includes a plurality of layers each being partitioned into one or more tiles that correspond to the processing units, and compiler determines the scaling factor for the computing time of each of the processing units in a corresponding tile of a corresponding layer of the NN based on the computing load of the corresponding tile and a critical computing load of a critical tile of the corresponding layer.

14. The apparatus of claim 12, wherein the dataflow type is cross-layer tiling, the NN includes a plurality of layers each being partitioned into one or more tiles, each of the processing units processes corresponding fused partitioned tiles of two or more of the layers, and the compiler determines the scaling factor for the computing time of each of the processing units in corresponding fused tiles at a corresponding synchronization stage of the NN based on the computing load of the corresponding fused tiles and a critical computing load of critical fused tiles at the corresponding synchronization stage.

15. The apparatus of claim 12, wherein the dataflow type is layer pipeline tiling, the NN includes a plurality of layers each being partitioned into one or more tiles, the processing units, one after another at each synchronization stage, process corresponding tiles of corresponding layers sequentially, and the compiler determines the scaling factor for the computing time of each of the processing units in a corresponding tile of a corresponding layer of the NN based on the computing load of the corresponding tile and a critical computing load of a critical tile of the corresponding layer.

16. The apparatus of claim 11, wherein the compiler adjusts the computing time of the processing units based on the scaling factors by employing dynamic voltage and frequency scaling (DVFS).

17. The apparatus of claim 16, wherein the compiler adjusts frequencies at which the processing units operate based on the scaling factors.

18. The apparatus of claim 16, wherein the compiler adjusts voltages applied to the processing units based on the scaling factors.

19. The apparatus of claim 11, wherein the compiler information further includes computing loads on the processing units for a plurality of dataflow types of the NN, and the compiler is further configured to calculate a sum of the computing loads on the processing units for each of the dataflow types, select one of the dataflow types based on the sums, and generate the firmware that corresponds to the selected dataflow type.

20. The apparatus of claim 11, wherein the processing units include deep learning accelerator (DLA) cores.
